(19) United States
(12) Patent Application Publication
(10) Pub. No.: US 2024/0263101 A1
(43) Pub. Date: Aug. 8, 2024

(54) METHOD OF MAKING A SELF-FILLING CANDLE

(71) Applicant: Afton Candle Inc., Hudson, WI (US)

(72) Inventors: Todd Nelson, Afton, MN (US); Tammi Nelson, Afton, MN (US); Andrew Bliese, Woodbury, MN (US)

(73) Assignee: Afton Candle Inc., Hudson, WI (US)

(21) Appl. No.: 18/429,842

(22) Filed: Feb. 1, 2024

Related U.S. Application Data
(60) Provisional application No. 63/483,032, filed on Feb. 3, 2023.

(51) Int. Cl. C11C 5/02; C11C 5/00

(52) U.S. Cl. CPC C11C 5/023; C11C 5/006

(57) ABSTRACT

A method of manufacturing self-filling candles uses a pour table and with cylindrical cavities and removable, insertable cores. The self-filling candle fills itself with melted wax to form a second candle for additional burning. The shape of the self-filling candle generally includes a hollow cylindrical candle body with the internal cavity having a solid bottom wall and extending upward to a top opening. The candle body is made of a single wax. A first wick is spirally located along the inside surface of the cylindrical sidewall, with its inner surface exposed. As the first wick is burned, melted wax pools in the cavity to form a second candle. A second wick, e.g., a wooden wick, is positioned in the bottom surface of the cavity, and is burned once the second candle has been formed. The manufacturing method is capable of making multiple self-filling candles with the first and the second wicks molded in place without the need for additional labor.

### CROSS-REFERENCE TO RELATED APPLICATION

The present application claims priority of U.S. Provisional Patent Application No. 63/483,032, filed Feb. 3, 2023, the content of which is incorporated herein by reference in its entirety.

### FIELD OF THE INVENTION

The present invention relates generally to the manufacturing of self-filling candles having a first and a second wick, and more specifically to a manufacturing method using a pouring table with multiple, cylindrical cavity molds and removable mold cores, along with lifting rings eject the candles from the cavity molds after the wax hardens. In the exemplary embodiment, both the first and the second wicks of the self-filling candles are molded in place without the need for additional labor after ejection.

### BACKGROUND OF THE INVENTION

Applicant has been making and selling self-filling candles that have a hollow cylindrical candle body with an internal cavity, a solid bottom wall and an open top. The candle body is made of a single wax. A first wick (e.g., a braided cotton wick) is spirally located along the inside surface of the cylindrical sidewall, with its inner surface exposed. As the first wick is burned, melted wax pools in the cavity to form a second candle on the solid bottom. A second wick, e.g., a wooden wick, is secured to the bottom wall and extends upward into the cavity. The second candle is burned once the second candle has been formed from melting the cylindrical sidewalls. Other self-filling candles have been disclosed in U.S. Pat. No. 9,033,701 (McWilliams) and U.S. Pat. No. 9,303,235 (Navarro). The McWilliams '701 patent describes a candle made of two different wax layers with different melting temperatures. Neither the McWilliams '701 patent nor the Navarro '235 patent address how to mold the candles or methods of manufacturing the candles.

Prior to this invention, self-filling candles have been made on an individual basis, using an inner cylindrical can and an outer cylindrical can. The braided cotton wick is wound around the smaller can to form a spiral along the portion of the sidewall above the bottom wall. The cotton wick is held to the inner can using one or more patches of soft wax, and an end of the wick is positioned above the expected top end of the cylindrical wall. The smaller can is then placed inside the larger second can, centered, and the wax is poured and hardened to form the cylindrical side wall. Then, the hardened wax is removed from the cans such that the braided cotton wick is in the sidewall with its inner side exposed to the cavity and its top end also being exposed. Subsequently, the sidewall tube is set on a table and wax is poured into the cavity to form the bottom wall. The wooden wick is placed in the bottom wall before it sets. This process is labor intensive, time-consuming and subject to human error.

The object of the invention is to provide a manufacturing process and equipment that can be used to reliably and efficiently produces self-filling candles on a large-scale basis.

### SUMMARY OF THE INVENTION

The invention uses a pouring table with an array (e.g. 12×8) of cavities to mold multiple self-filling candles in a single batch. Powered lifting rings lift the hardened candles from the molds, preferably with both a spiral cotton wick and a wooden wick in place without the need for additional labor.

In the exemplary embodiment of the invention, the shape of the produced self-filling candle generally includes a hollow cylindrical candle body having a solid bottom wall and an internal cavity extending upward to a top opening. The candle body is made of a single wax. A first wick (made from a cord, preferably a cotton cord) is spirally located along the inside surface of the cylindrical sidewall, with its inner surface exposed. As the first wick is burned, melted wax pools in the cavity to form a second candle. A second wick, e.g., a wooden wick, is positioned in the bottom surface of the cavity, and is burned once the second candle has been formed. The invention as mention is directed at producing such a self-filling candle. Many aspects of the invention can be implemented, however, to produce self-filling candles having shapes other than cylindrical sidewalls.

In accordance with the exemplary embodiment of the invention, the method involves the use of a pouring table with a horizontal surface and a plurality of molding cavities extending downward from the horizontal surface of the pouring table. The molding cavities are desirably arranged in an array, e.g. a 12 by 8 array, although other arrangements are possible within the scope of the invention. The pouring table also includes the use of a removable mold core for each of the molding cavities. An outer mold, e.g. a cylindrical outer mold, is provided for each cavity. The removeable mold core is affixed to a stationary base in the respective molding cavity, e.g. using a threaded shaft or other means such as a bayonet latch. Powered lifting rings, e.g. hydraulically powered lifting rings, are located at the bottom of each cavity, serve as the floor for the melted wax in the space between the cylindrical outer mold and the core, and are configured to raise the hardened wax surrounding the core from the cylindrical mold in the respective cavity. In the preferred embodiment of the present invention, a finished self-filling candle with a spiral cotton wick in the cylindrical sidewall and a wooded wick in the bottom wall are ejected from the molds by the powered lifting ring. Also, the mold core is removable from the molding cavity in order to facilitate the releasable attachment of the first wick to the mold core and the wrapping of the first wick in a spiral around the mold core. The first wick is desirably attached using wax adhesive which has been found strong enough to hold cotton wicks to the surface of the mold core while the wick is wrapped, affixed to the base of the respective mold cavity and the melted wax is poured. The wax adhesive melts and mixes with the melted wax at later stages of the process and is not conspicuous in the final product.

Once the wick made from a cord is wrapped around the respective mold core, each of the mold cores with an attached, wrapped wick is affixed to the base or floor of the respective molding cavity. In the exemplary embodiment of the invention, the bottom of each mold core includes an annular beveled edge, and a circular bottom surface. The base or floor of each molding cavity is configured to receive the bottom portion of the mold core and, in the exemplary embodiment, has a threaded shaft extending upward from the center of the cavity floor to which the mold core is screwed onto. The lifting ring is located in a circumferential area of the cavity floor surrounding a beveled region on the cavity floor. When the mold core is lowered into the cavity, the annular beveled edge on the core is seated in beveled cavity floor, and is tightened onto the threaded shaft to properly position the core and prevent leaking when the wax is poured. The top surfaces of the mold core desirably have indents to facilitate power-assisted or automated turning of the mold cores to affix the mold cores in place, and to remove the mold cores in preparation for the next batch.

As discussed above, it is desirable that the process produce a self-filling candle with an integral bottom as well. To do so, the height of a top surface of each mold core is sunken compared to the height of the horizontal surface of the pour table. The flooding of the pouring table, discussed below, also fills the open volume in the molding cavity above the sunken top surface of the mold core with wax. The hardened wax in the volume above the sunken top surface of the mold core and below the height of the horizontal surface of the pour table forms the bottom wall of the respective self-filling candle.

It is also desirable to install the wooden wick during the molding process. In the exemplary embodiment of the invention, each mold core includes a wick slot for a wooden wick in the top surface of the mold core. The method further comprises the step of placing the wooden wick in a wick sustainer and positioning the wooden wick in the wick slot of the mold core with at least part of the wick sustainer located above the top surface of the mold core. In the exemplary embodiment, this done prior to inserting the mold core into the respective molding cavity. It is desirable that the thickness of the bottom wall of the candle be sufficient to cover the wick sustainer and ensure that it is fully embedded, e.g., about 0.45 inches in the exemplary embodiment.

Once the mold cores (with the wicks attached) have been inserted into the cavities and affixed, the pouring table and the cylindrical molds are preheated to e.g. 100-110° F. After preheating the pouring table, the pouring table is flooded with melted wax to completely fill the plurality of cylindrical molds containing the wrapped cylindrical mold cores. In the exemplary embodiment, the melted wax is flooded to a level in which an excess layer of wax is provided above the horizontal surface. The thickness of the excess level is e.g. 0.5 inches and its purpose is to ensure even and uniform filling of the cavities. Next, the pouring table and the outer molds are cooled (e.g. room temperature cooling fluid) to harden the wax in the cavities. The cooling process should take ten to fifteen minutes. At that point, excess wax on the pouring table above and around the molding cavities is scraped and removed. In the final step, each lifting ring is activated to push the bottom of the cylindrical vertical wall of the candle upward relative to the stationary mold core. The lifting rings push the hardened wax candles upward from the respective cavities and off the mold cores, with a spiral wick in each cylindrical sidewall and a wooden wick mounted to each bottom wall.

It should be apparent to those skilled in the art that the invention enables the production of self-filling candles on a large scale, and in reliable manner. Those skilled in the art will also recognize that certain aspects of the invention can be implemented without implementing other aspects of the invention. It should also be recognized that the invention has been described in connection with an exemplary embodiment in which the sidewalls are cylindrical. It is contemplated within the scope of the invention, however, that self-filling candles having other shapes, such as square, rectangular or oval sidewalls can be made using the invention by changing the shapes of the molds and mold cores, and otherwise accommodating the change in shape of the molds.

### BRIEF DESCRIPTION OF THE DRAWINGS

FIG. 1A is a perspective view of a removable molding core with a cotton wick wrapped around its outer surface.

FIG. 1B is a bottom perspective view of the removeable mold core showing a threaded opening to enable attachment of the molding core within a molding cavity in the pouring table.

FIG. 2A is a perspective view showing a pouring table with an array of cylindrical molding cavities.

FIG. 2B is a downward looking view of a molding cavity showing a lifting ring at the bottom of the cavity.

FIG. 2C is view illustrating lifting rings raised on the pouring table shown in FIGS. 2A and B.

FIG. 3 is a perspective view of a molding core with a cotton wick wrapped around its outer surface and a wooden wick and wick sustainer mounted to the top of the core mold.

FIGS. 4 and 5 show a molding core (with wicks attached) lowered into one of the molding cavities.

FIGS. 6A and 6B show wooden wick secured within a metal wick sustainer.

FIGS. 7A-7D illustrate a plastic wick insert that is threadably secured within a threaded opening in the top surface of the core mold.

FIG. 8 shows the pouring table with an array of molding cavities and molding cores, each molding core having a cotton wick and wooden wick attached and lowered into the respective cavities.

FIG. 9 shows the pouring table being filled with melted wax.

FIG. 10 shows the pouring table once the melted wax has been poured over the array of cavities.

FIG. 11 is a top perspective view of a self-filling candle constructed in accordance with an exemplary embodiment of the invention.

These drawings illustrate an exemplary embodiment of carrying out the invention, namely using a pouring table with an array of molding cavities to manufacture multiple self-filling candles in a batch.

### DETAILED DESCRIPTION

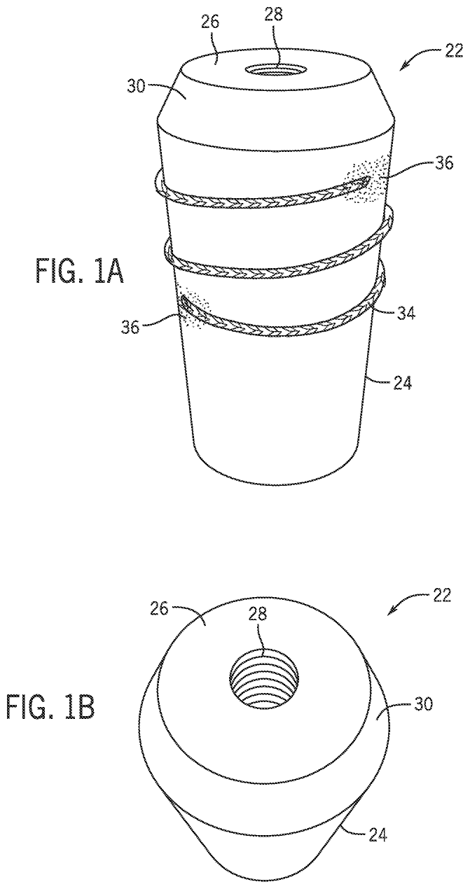

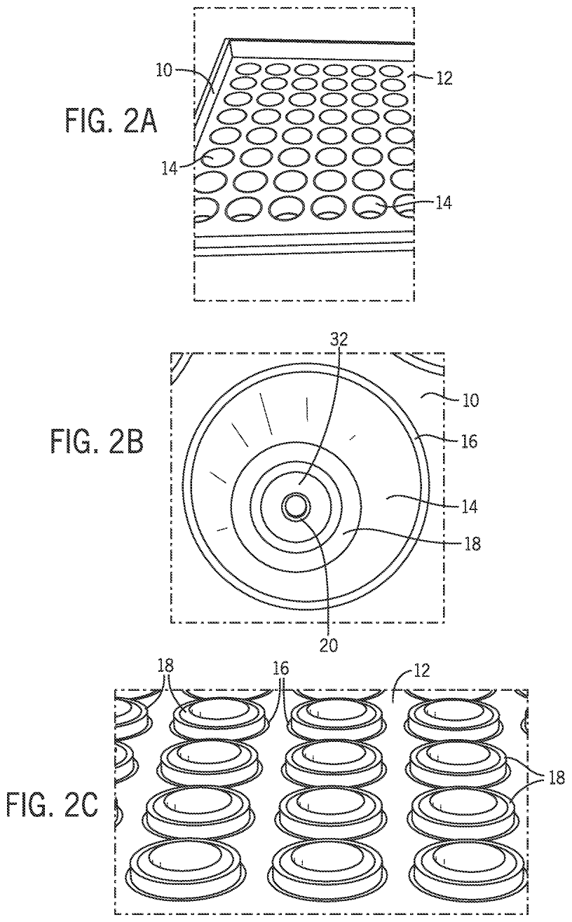

Referring first to FIGS. 2A and 2B, a pouring table 10 has a horizontal surface 12 and an array of molding cavities 14 in the horizontal surface 12 of the pouring table 10. FIG. 2B shows an individual molding cavity 14 with a lifting ring 18 located in a recess at the bottom of the cavity 14. The bottom surface of the cavity 14 has a threaded shaft 20 to which a mold core 22, see FIGS. 1A and 1B, is attached. Still referring to FIG. 2B, the outer surface of the cavity 14 is defined by a cylindrical mold 16. The outer cylindrical mold 16 defines the outer wall of the self-filling candle when the wax is poured. In FIG. 2B, the lifting ring 18 is in the down position. In the exemplary embodiment of the invention, the lifting ring 18 in FIG. 2B as well as the lifting rings in the other cavities 14 in the array shown in FIG. 2A are preferably raised and lowered contemporaneously as various steps of the candle making process. In the exemplary embodiment, a hydraulic drive system raises and lowers the lifting rings 18 although the invention can be implemented using other kinds of drives such as pneumatically or electrically powered drive systems.

FIGS. 1A and 1B show a mold core 22 that is adapted to be attached to the threaded shaft 20 in one of the respective cavities 14. The mold cores 22 have a cylindrical outer wall 24. This cylindrical wall 24 of the mold core 22 forms the inner surface of the cylindrical wall of the self-filling candle. In FIGS. 1A and 1B, the molding core 22 is illustrated with the bottom end 26 facing upward. The bottom surface 26 of the mold core 22 includes a threaded opening 28 that enables the mold core 22 to be removably attached to the threaded shaft 20 in the respective mold cavity 14. The base of each core 22 has an annular beveled edge 30 between the cylindrical wall 24 and the bottom surface 26. Referring to FIG. 2B, the bottom of each cavity 14 includes a circular recess 32 that has matching beveled side surfaces configured to engage the annular beveled edge 30 on the base of the molding core 22. The threaded shaft 20 is located in the center of the circular recess 32 of the molding cavity 14. With the lifting ring 18 lowered to the fully down position in the molding cavity 14, the mold core 22 (with the wicks 34 and 38) is tightened onto the threaded shaft 20 such that the annular beveled edge 30 on the mold core 22 seats against the matching beveled side surfaces 32 of the circular recess of the molding cavity 14. This engagement is tight and does not allow wax to leak beyond the point of contact. The lifting ring 18 is also configured to provide a tight seal when it is in the fully down position. FIG. 2C shows the lifting rings 18 in the fully up position (without candles removed). The upper surface of the lifting ring 18 forms a mold for the top of the cylindrical wall of the respective candle. Using the lifting rings 18 to push the cylindrical walls of the candle upward from the molding cavity is particularly reliable.

Referring to FIG. 1A, a first wick 34 is attached to the outside diameter 24 of the mold core 26 using wax based adhesive 36. The first wick 34 can be attached manually, or with the aid of an automated winder. In the preferred embodiment, the first wick 34 comprises a braided wick with a cotton core. However, it is appreciated that various other types of wicks may be utilized for the first wick 34. The first wick 34 is attached so that it spirals within a cylindrical side wall of the self-filling candle but will not extend to the base of the candle. Referring for example to FIG. 12, the wick 34 spirals around the inside surface of the cylindrical wall of the candle 100 with a part 102 of the first wick 34 exposed near the upper opening of the candle 100 and the other end of the spiral cotton wick 34 stopping at a height above the floor or bottom wall 104 of the candle 100, thereby enabling the bottom portion of the cylindrical wall to capture melted wax within the central cavity of the candle 100.

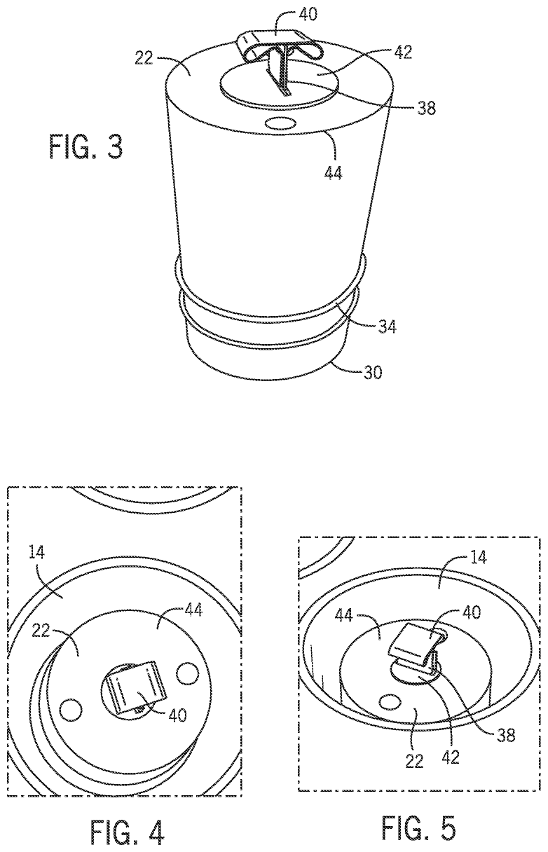

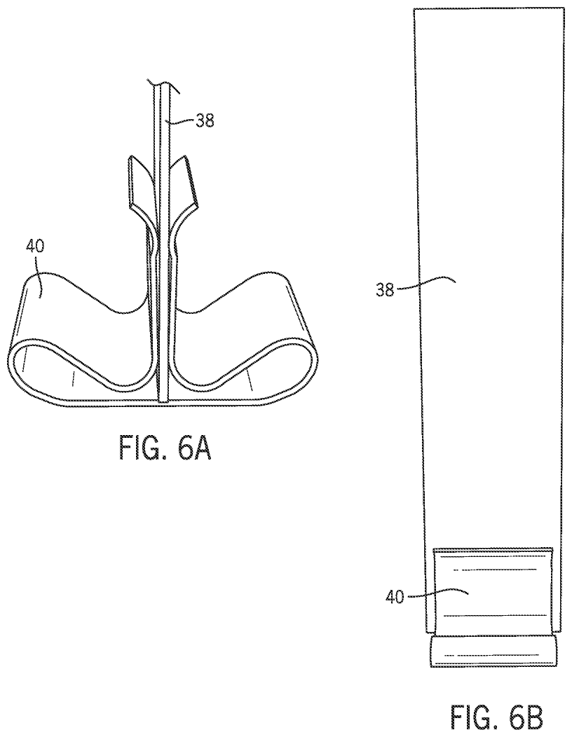

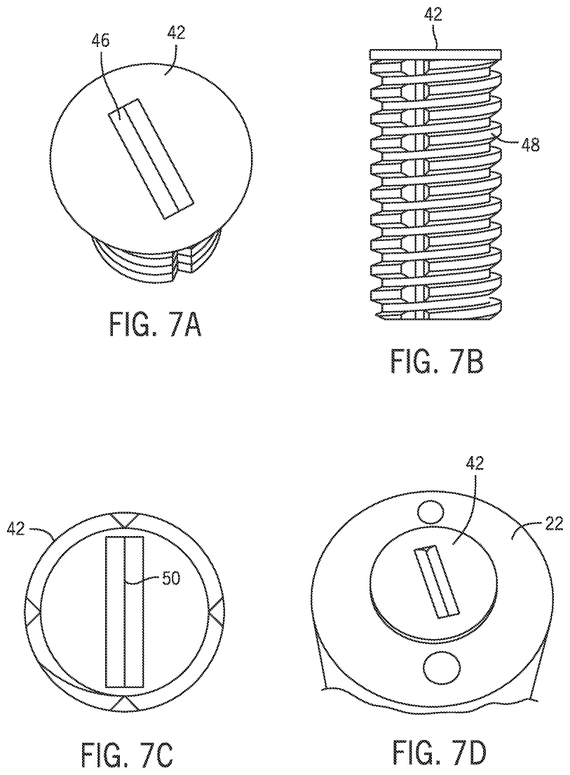

FIG. 3 shows a mold core 22 with the wooden wick 38 installed in addition to the spiral wick 34. In FIG. 3, the mold core 22 is shown with its top surface 44 facing upward and the lower beveled annular surface 30 at the base on the bottom of the mold core 22 facing downward. This orientation shown in FIG. 3 is the orientation of the mold core 22 when it is inserted into the respective cavity 14 and attached to the threaded shaft 20. FIGS. 4 and 5 show the mold core 22 when it is mounted in a respective cavity 14. Referring to FIGS. 6A and 6B in addition to FIGS. 3-5, the wooden wick 38 is held in a metal sustainer 40. The wooden wick 38 held in the metal sustainer 40 is then inserted into a slot that extends into the mold core 22, and more specifically within a plastic insert 42 that is inserted into a threaded opening in the top surface 44 of the mold core 22. FIGS. 7A-7B show an insert 42 made of plastic that is screwed into the opening in the top surface 44 of the respective mold core 22. The insert 42 includes slot 46 designed to accommodate the wooden wick 38. The top of the slot 46 includes lips to provide a seal against the wooden wick 38. The bottom of the slot 50, FIG. 7C is open since the wooden wick 38 is longer than the insert 42. The threads 48, FIG. 7B on the insert 42 are used to secure the insert 42 within the threaded opening in the top surface 44 of the mold core 22.

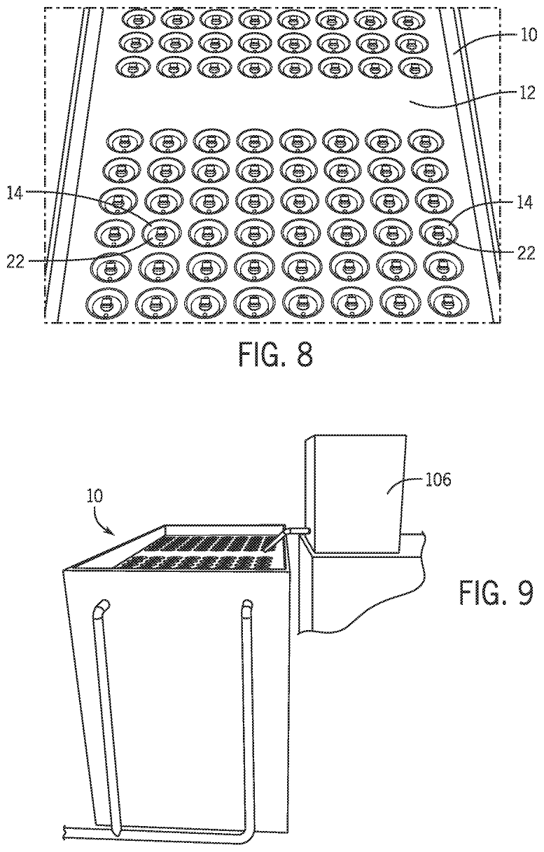

FIGS. 5 and 8 show the removable mold cores 22 (with the wrapped cotton wick and the wooden wick installed) lowered into and mounted in the molding cavities 14 prior to pouring the melted wax. The mold cores 22 are recessed below the horizontal surface 12 of the pouring table 10 prior to pouring the melted wax. The mold cores 22 are recessed about 0.45″ below the horizontal surface 12 of the pouring table 10 to allow for the bottom wall 104 (FIG. 11) of the candle 100 to be formed with the wooden wick 38 and metal sustainer 40 embedded within the bottom wall 104 of the candle 100.

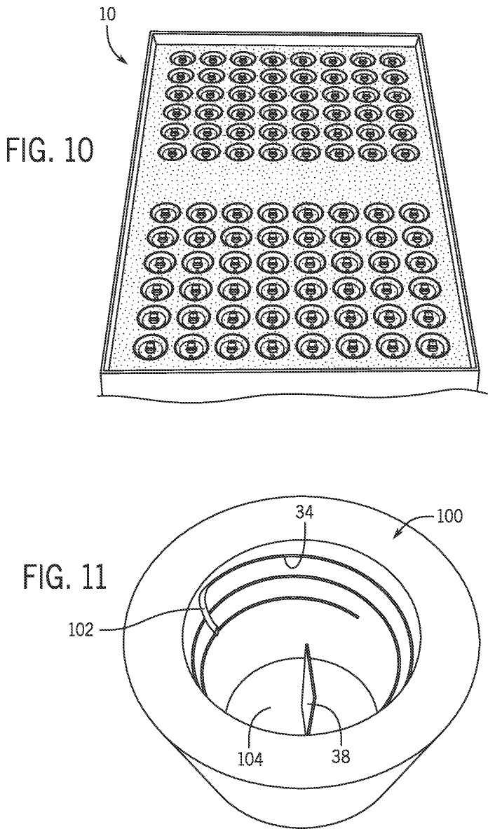

Hot water is circulated through the pouring table 10 (100-110 degrees F.) to preheat the table. A portable wax melting system 106 is moved next to the pouring table 10, see FIG. 9. The pouring table 10 is then flooded with melted wax completely filling the molding cavities 14 (with the mold cores 22 mounted in the cavities 14) and covering them with approximately ½″ of wax, see FIG. 10.

Cooling water is then circulated through the pouring table 10 to rapidly cool the wax. FIG. 10 shows the poured wax being cooled on the pouring table 10. Once the wax has cooled (e.g., 10-15 mins), the excess wax is scrapped off the top of the pouring table 10 and recycled. The hydraulic lifting rings 18 then raise the solidified wax candles 100 out of the cavities 14 revealing a complete set of self-filling candles 100 which contain both the cotton wick 34 and the wooden wick 38 as shown in FIG. 11.

The method can be used with various types of wax and wax blends. In the exemplary embodiment, the wax is BW-93301. BW-93301 is a fully refined paraffin/microcrystalline wax blend with stable color and can be used as a base product or as a blending component. BW-93301 is refined to meet the following consistent and narrow specification requirements.

TABLE 1
Wax Specifications:

| | ASTM Test | Typical | Value | |
|---|---|---|---|---|
| Properties | Method | Values | Ranges | |
| Melt Point (F.) | D-87 | 157 | 154-159 | |
| Oil Content % | D-721 | .5 | .5% | max. |
| Penetration @77 (F.) | D-1321 | 14 | 12-16 | |
| Color | D-156 | +30 | +30 | min. |

| | | | |
|---|---|---|---|
| Viscosity @ 210 (F.) SUS | D-88 | 44 | 43-45 |

While the invention can be implemented with different candle waxes, BW-93301 has been found to release easily and reliably from the cavities 12 and the mold cores 22, provides adequate strength when hardened for reliable removal from the cavities 12 and also produces a desirable sheen on the sidewalls of the self-filling candle.

What is claimed is:

1. A method of forming a self-filling candle comprising the steps of:
a) providing a pouring table with a horizontal surface and a plurality of molding cavities extending downward from the horizontal surface of the pouring table, each said molding cavity including an outer mold;
b) providing an insertable and removable mold core for each molding cavity;
c) providing a lifting ring at the bottom of each cavity, each said lifting ring being configured to lower to the floor of the cavity and to raise;
d) releasably attaching a first wick made from a cord and wrapping the first wick around each mold core;
e) placing each of the lifting rings in a fully down position at the floor of the molding cavity;
f) affixing each mold core with an attached, wrapped first wick in a respective molding cavity;
g) preheating the pouring table and the outer molds;
h) flooding the pour table with melted wax to completely fill the plurality of molding cavities containing the mold cores, each with an attached, wrapped first wick;
i) cooling the pour table and the outer molds to cool and harden the wax in the molding cavities;
j) removing excess wax on the pour table above and around the molding cavities; and
k) raising the lifting rings to push the hardened wax with the wrapped first wicks substantially from the respective molding cavities.

2. The method of forming a self-filling candle as recited in claim 1 wherein the height of a top surface of each mold core is sunken compared to the height of the horizontal surface of the pour table, and the flooding of the pouring table in step h) also fills the open volume in the molding cavity above the sunken top surface of the mold core with wax; wherein the hardened wax in the volume above the sunken top surface of the mold core and below the height of the horizontal surface of the pour table forms a bottom wall of the respective self-filling candle.

3. The method of forming a self-filling candle as recited in claim 2 wherein each mold core includes a wick slot for a wooden wick in the top surface of the mold core, and the method further comprises the step of placing a wooden wick in a wick sustainer for each of the mold cores, and positioning the wooden wick in the wick slot of the mold core with at least part of the wick sustainer located above the top surface of the mold core, prior flooding the pour table with melted wax.

4. The method of forming a self-filling candle as recited in claim 1 wherein:
the base of each mold core includes an annular beveled edge, and a bottom circular surface;
each molding cavity includes a circular recess with matching beveled side surfaces configured to receive the annular beveled edge of the base of the respective mold core and means for affixing a removable mold core to a floor of the molding cavity;
the base of each mold core is lowered into the respective molding cavity and removably affixed to the floor of the molding cavity such that the annular beveled edge of the mold core seats on the matching beveled side surfaces of the circular recess of the molding cavity; and
the lifting ring for each molding cavity is located annularly around the affixed mold core.

5. The method of forming a self-filling candle as recited in claim 4 wherein means for affixing a removable mold core to a floor of the molding cavity comprises a threaded shaft extending upward from the floor of the molding cavity, and the bottom surface of each mold core included a threaded hole to receive the respective threaded shaft.

6. The method of forming a self-filling candle as recited in claim 2 wherein the top surface of the mold core when inserted and affixed is between 0.4 and 0.6 inches below the horizontal surface of the pour table.

7. The method of forming a self-filling candle as recited in claim 3 wherein the entire sustainer is contained within the wax bottom of the candle after it is hardened and ejected from the molding cavity.

8. The method of forming a self-filling candle as recited in claim 3 wherein the wick slot is sealed around the wooden wick to substantially prevent melted wax from leaking into the slot when the melted wax is poured onto the horizontal surface of the pour table and into the molding cavities.

9. The method of forming a self-filling candle as recited in claim 1 wherein wax adhesive is used to releasably attach the first wick to the mold core when wrapping the first wick.

10. The method of forming a self-filling candle as recited in claim 1 wherein flooding the pouring table with melted wax further comprises flooding the melted wax to a level in which an excess layer of wax is provided above the horizontal surface, and removing excess wax on the pouring table above and around the molding cavities includes scraping the excess layer of wax after it has hardened.

11. The method of forming a self-filling candle as recited in claim 10 wherein the wax cools for 10 to 15 minutes prior to scraping the excess layer.

12. The method of forming a self-filling candle as recited in claim 10 wherein the first wick made from a cord comprises cotton.
